(19) United States
(12) Patent Application Publication
(10) Pub. No.: US 2004/0098986 A1
(43) Pub. Date: May 27, 2004

(54) Methods and apparatus for generating and storing solar energy

(76) Inventor: Robert Z. Litwin, Canoga Park, CA (US)

Correspondence Address: HARNESS, DICKEY & PIERCE, P.L.C., P.O. BOX 828, BLOOMFIELD HILLS, MI, 48303, US

(21) Appl. No.: 10/306,480

(22) Filed: Nov. 27, 2002

(51) Int. Cl. F03G 6/00; F03G 7/00; B60L 8/00; B60K 16/00

(52) U.S. Cl. 60/641.8; 60/641.12

(57) ABSTRACT

A method for generating and storing electrical energy is provided that includes utilizing solar radiation to generate electrical power; delivering a first portion of the generated electrical power to at least one consumer while storing a second portion of the generated electrical power as kinetic energy to accelerate at least one flywheel; when the generated electrical power is insufficient for the consumer(s), converting kinetic energy stored in the flywheel(s) back to electrical power; and delivering the electrical power obtained by converting the kinetic energy stored in the flywheel(s) to the consumer(s).

### FIELD OF THE INVENTION

The present invention relates to generation of electric power and more particularly to methods and apparatus for extending the availability of solar-generated electrical power.

### BACKGROUND OF THE INVENTION

Solar concentrators can produce electrical power from the sun for small electrical demands, if operated singularly, or for utility applications if many concentrators are operated together. At least one such system produces thermal energy that is converted into electrical energy. However, to generate energy, solar concentrators require the presence of the sun. At night, there is no energy production, and any consumer energy needed must be supplied either from a supplemental conventional source or from energy produced by the concentrator and stored during the day. Known storage methods include thermal storage, chemical storage, batteries, compressed gas, and hydrogen production, but these storage systems may be economically or physically impractical for small amounts of energy storage in certain installations.

### SUMMARY OF THE INVENTION

The present invention, in various configurations, therefore provides a method for generating and storing electrical energy. The method includes utilizing solar radiation to generate electrical power; delivering a first portion of the generated electrical power to at least one consumer while storing a second portion of the generated electrical power as kinetic energy to accelerate at least one flywheel; when the generated electrical power is insufficient for the consumer(s), converting kinetic energy stored in the flywheel(s) back to electrical power; and delivering the electrical power obtained by converting the kinetic energy stored in the flywheel(s) to the consumer(s). (Generated electrical power is also considered insufficient when it is unavailable at night.)

Also in various configurations, the present invention provides an apparatus for generating and storing electrical energy. The apparatus includes an energy generator system configured to generate electrical power from solar radiation; a flywheel; a motor/generator assembly configured to convert kinetic energy stored in the flywheel to electrical power and to accept electrical power generated by the energy generator system to accelerate the flywheel; and a power splitter configured to deliver a first portion of the generated electric power to at least one consumer, to deliver a second portion of the generated electric power to the motor/generator, and to deliver electrical power generated from kinetic energy stored in the flywheel when the energy generator system generates insufficient electrical power for the consumer(s).

Configurations of the present invention are useful for energy storage in solar power generating stations, particularly those utilizing solar concentrators. Moreover, the storage of kinetic energy in a flywheel avoids the use of thermal storage, chemical storage, batteries, compressed gas, hydrogen production, and other storage systems that are economically or physically impractical for particular installations. Configurations of the present invention can be utilized to provide power derived from diurnal solar energy on a 24-hour basis to consumers.

Further areas of applicability of the present invention will become apparent from the detailed description provided hereinafter. It should be understood that the detailed description and specific examples are intended for purposes of illustration only and are not intended to limited the scope of the invention.

### BRIEF DESCRIPTION OF THE DRAWINGS

The present invention will become more fully understood from the detailed description and the accompanying Figures, in which:

FIG. 1 is representative of various configurations of an apparatus for generating and storing electrical energy.

FIGS. 2 and 3 are representative of another configuration of solar concentrator suitable for use in configurations of the present invention, wherein FIG. 2 is a cut away view at plane II in the perspective view of FIG. 3.

FIGS. 4 and 5 are representative of yet another configuration of solar concentrator suitable for use in configurations of the present invention, wherein the solar concentrator is a Fresnel lens, wherein the Fresnel lens is shown in a partial cut away side view in FIG. 4.

### DETAILED DESCRIPTION OF THE PREFERRED EMBODIMENTS

The following description of the preferred embodiment(s) is merely exemplary in nature and is in no way intended to limit the invention, its application, or uses.

As used herein, the term “motor/generator assembly” refers to a combination of a motor and a generator. The motor and the generator may be, but need not necessarily be, the same component. More particularly, the same rotor and stator combination may be a motor when electrical power is applied and a generator when electrical power is extracted from kinetic energy moving the rotor. In such a case, the rotor and stator combination is referred to as “a single motor.” Also as used herein, electrical power produced from solar energy prior to being stored temporarily in the kinetic energy of a rotating flywheel is referred to as “generated” electrical power, whereas electrical power produced from the stored kinetic energy of the rotating flywheel is referred to as electrical power “converted” from the stored kinetic energy. The distinction between “generated” and “converted” electrical power is helpful to indicate the source of the electrical power. Note that “generated” electrical power is obtained from energy added to a system by solar radiation, whereas “converted” electrical power is obtained from a source of stored energy, e.g., a flywheel.

Also as used herein, unless otherwise explicitly stated, the terms “a,” “an,” “the,” “said,” and “at least one” are not intended to be limited in number to “one,” but rather are intended to be read as encompassing “more than one” (i.e., a plurality) as well.

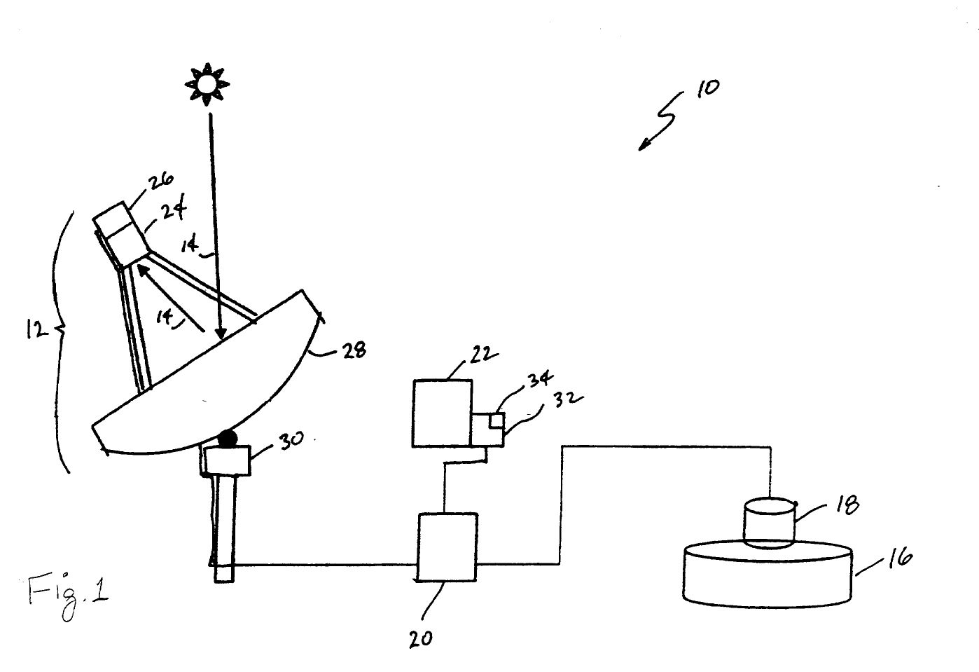

In various configurations and referring to FIG. 1, the present invention is an apparatus for generating and storing electrical energy 10. The apparatus comprises an energy generator system 12 configured to generate electrical power from solar radiation 14, and at least one flywheel 16. A motor/generator assembly 18 is mechanically coupled to flywheel 16 and electrically coupled to energy generator system 12. Motor/generator assembly 18 converts kinetic energy stored in rotating flywheel 16 into electrical energy or accepts electrical power generated by energy generator system 12, depending upon whether energy is being taken from or stored, respectively. A power splitter 20 is also provided to deliver at least a first portion of the generated electrical power to a consumer 22 and a second portion of the generated electrical power to motor/generator assembly 18. (“Power to a consumer,” as used herein, refers to power being supplied to a consumer's residence or business, or to a consumer's electrical and/or electronic appliances and/or lighting. FIG. 1 is intended to represent this meaning.) The second power portion is converted into kinetic energy that accelerates flywheel 16, thus storing the electric energy in the kinetic energy of the rotating flywheel.

When solar radiation 14 is available, such as in daytime, energy generator system 12 is utilized to generate electrical power for consumer 22, i.e., the first portion of electrical power. In various configurations of the present invention, an excess of electrical power is available for the needs of consumer 22, so that this excess represents the second portion of electrical power that is stored in the kinetic energy of rotating flywheel 16. It is envisioned that consumer 22 will require electrical power not only during daylight hours, but also at night. Therefore, at times when energy generator system 12 is not able to supply the needs of consumer 22, motor/generator assembly 18 is utilized to extract energy from the kinetic energy stored in rotating flywheel 16 and convert it to electrical power, which is delivered to consumer 22. Thus, electrical power is available to consumer 22 at night. With the selection of appropriate components to supply several kilowatts per customer, if customers represent typical residences, apparatus 10 can be used by a utility company to supply electrical power to whole city blocks or neighborhoods. However, apparatus 10 can be scaled for smaller or larger power generation and storage capabilities, for example, a single home or business or a portion thereof. In many configurations, flywheel(s) 16 are buried underground to protect property and personnel in the event imbalances in the flywheel or breakage results in a flywheel 16 or a portion thereof becoming loosened from its support. Flywheel(s) 16, in many configurations, will be located at a central generating plant, along with energy generator system 12.

In some configurations, motor/generator assembly 18 comprises a single motor configured to operate both as a motor to accelerate flywheel 16 during daylight hours and as a generator to convert kinetic energy stored in flywheel 16 back to electrical power at night. Also in some configurations, a plurality of flywheels 16 and corresponding motor/generator assemblies 18 are utilized in series or in parallel to increase energy storage capacity of apparatus 10.

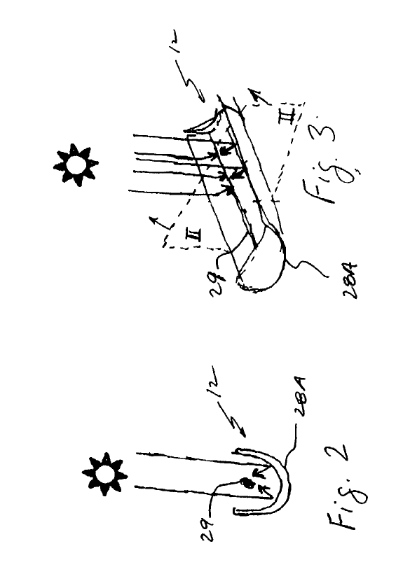

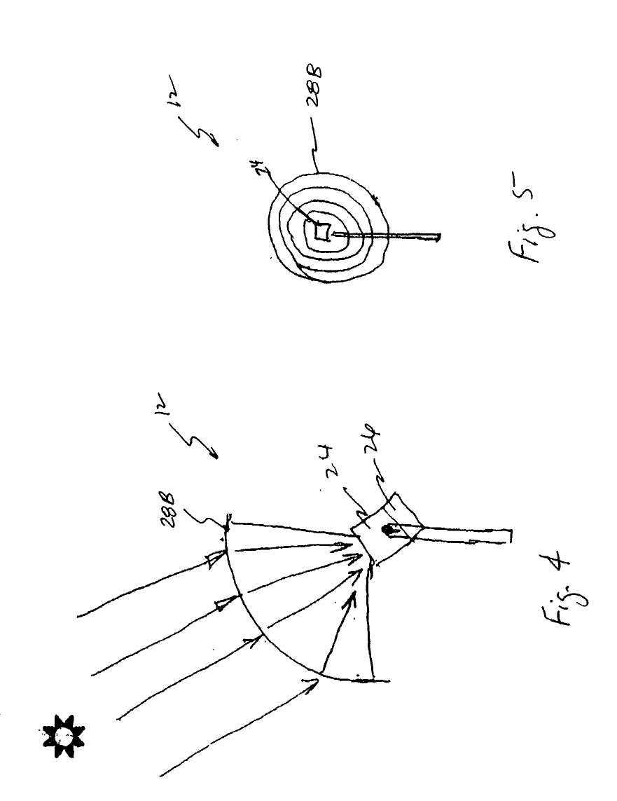

In some configurations, energy generator system 12 comprises a heat engine 24, such as a Stirling engine, and a generator 26 to convert energy from heat engine 24 into electrical power. Some configurations of energy generator system 12 further comprise a solar concentrator 28, such as a reflecting dish, to concentrate sufficient solar energy at heat engine 24 to generate electricity for consumer 22 and an excess amount that can be stored as kinetic energy by flywheel 16. In many configurations, a motor 30 is provided to move solar concentrator 28 to track movement of the sun in the sky to increase the amount of energy that is available for generating electrical energy throughout the day. In some configurations, energy generator system 12 comprises photovoltaic cells that directly convert light into electrical energy. Energy generator system 12 in some configurations may comprise other devices or combinations of devices that convert solar energy into electrical energy. For example, in some configurations and referring to FIGS. 2 and 3, energy generator system 12 comprises a trough concentrator 28A and a plurality of photovoltaic cells 29 located at a linear focal region of trough concentrator 28A. In some configurations and referring to FIGS. 4 and 5, energy generator system 12 comprises a thin refracting lens 28B such as a Fresnel lens that concentrates light from the sun, for example, on a heat engine 24.

In some configurations, a plurality of energy generator systems 12, which need not all have the same configuration, are provided to increase the electrical power generating capability of apparatus 10, and/or a plurality of flywheels 16 and a corresponding motor/generator assemblies 18, and/or a plurality of consumers 22.

In at least some areas, energy purchased by utility companies at peak periods is more expensive than energy purchased at other times. For example, energy purchased during peak hours from 2:00 p.m. to 8:00 p.m. may be more expensive than energy purchased at other times. The higher cost of this energy may be passed on to consumers. For example, some utilities pass the higher costs on as a blended charge, within limits that may be set by regulatory agencies. Configurations of the present invention increase dispatchability and make electrical power more available to consumers during peak hours, making the available energy more valuable. Extra revenue from the sale of such energy may thus be used to finance any added cost of equipment needed for generation.

In some areas, utility companies may be permitted to charge different rate amounts for electrical power consumed by a customer depending on the time of day. For example, a higher rate might be charged for electrical power consumed at night than during the day to pay for acquisition and maintenance costs associated with energy storage. Therefore, in some configurations, customer 22 is provided with an electric meter 32 that is configured to separately measure usage of the generated electrical power and usage of the electrical power converted from the stored kinetic energy in flywheel 16. For example, electric meter 32 may be an electronic meter that includes a timer 34 configured to indicate when solar radiation is available. For example, timer 34 is programmed with sunrise and sunset times for location of apparatus 10. When customer 22 utilizes electrical power between sunrise and sunset, electronic meter 32 increments its usage measurements as recorded in a first addressable memory. When consumer 22 utilizes electrical power between sunset and sunrise, electronic meter 32 increments its usage measurement as recorded in a second addressable memory. When meter 32 is read, both the first addressable memory and the second addressable memory are read, and customer 22 is billed at different rates for the different usage periods.

Configurations of the present invention can replace other power generation systems or may be utilized in conjunction with other power generation systems and may service a plurality of consumers and/or comprise a plurality of solar concentrators, flywheels, motor/generator assemblies, etc. Thus, configurations that comprise a solar concentrator, a flywheel, a motor/generator assembly, etc., may comprise one or more of any or all of the recited items, unless explicitly stated.

It will be observed that configurations of the present invention are useful for energy storage in solar power generating stations, particularly those utilizing solar concentrators. Moreover, the storage of kinetic energy in a flywheel avoids the use of thermal storage, chemical storage, compressed gas, batteries, hydrogen production, and other storage systems that are economically or physically impractical for particular installations. Configurations of the present invention can be utilized to provide power derived from solar energy on a 24-hour basis or for peaking applications to consumers.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A method for generating and storing electrical energy, said method comprising:
utilizing solar radiation to generate electrical power;
delivering a first portion of the generated electrical power to at least one consumer while storing a second portion of the generated electrical power as kinetic energy to accelerate at least one flywheel;
when the generated electrical power is insufficient for the at least one consumer, converting kinetic energy stored in the at least one flywheel back to electrical power; and
delivering the electrical power obtained by converting the kinetic energy stored in the at least one flywheel to the at least one consumer.

2. A method in accordance with claim 1 wherein said storing a second portion of the electrical power as kinetic energy comprises operating the generator as a motor to accelerate rotation of the at least one flywheel.

3. A method in accordance with claim 1 wherein said utilizing solar radiation to generate electrical power comprises converting thermal energy to electrical energy utilizing a heat engine and a generator.

4. A method in accordance with claim 3 wherein the heat engine is a Stirling engine.

5. A method in accordance with claim 1 further comprising concentrating the thermal energy utilizing a solar concentrator.

6. A method in accordance with claim 5 wherein the solar concentrator comprises a reflecting dish.

7. A method in accordance with claim 5 wherein the solar concentrator comprises a reflecting trough.

8. A method in accordance with claim 5 wherein the solar concentrator comprises a refracting lens.

9. A method in accordance with claim 5 further comprising moving the solar concentrator to track movement of the sun in the sky.

10. A method in accordance with claim 1 wherein said utilizing solar radiation to generate electrical power comprises utilizing photovoltaic cells to generate the electrical power.

11. A method in accordance with claim 1 further comprising charging the at least one consumer a different rate for generated electrical power than for electrical power converted from the stored kinetic energy in the at least one flywheel.

12. A method in accordance with claim 1 wherein the at least one flywheel is buried underground.

13. An apparatus for generating and storing electrical energy, said apparatus comprising:
an energy generator system configured to generate electrical power from solar radiation;
a flywheel;
a motor/generator assembly configured to convert kinetic energy stored in the flywheel to electrical power and to accept electrical power generated by the energy generator system to accelerate the flywheel; and
a power splitter configured to deliver a first portion of the generated electric power to at least one consumer, to deliver a second portion of the generated electric power to the motor/generator, and to deliver electrical power generated from kinetic energy stored in the flywheel when the energy generator system generates insufficient electrical power for the at least one consumer.

14. An apparatus in accordance with claim 13 wherein the motor generator assembly comprises a single motor configured to operate both as a motor to accelerate the flywheel and in reverse as a generator to convert kinetic energy stored in the flywheel back to electrical power.

15. An apparatus in accordance with claim 13 wherein said energy generator system comprises a heat engine and a generator.

16. An apparatus in accordance with claim 15 wherein the heat engine comprises a Stirling engine.

17. An apparatus in accordance with claim 13 wherein the energy generator system comprises a solar concentrator.

18. An apparatus in accordance with claim 17 wherein the solar concentrator comprises a reflecting dish.

19. An apparatus in accordance with claim 17 wherein the solar concentrator comprises a reflecting trough.

20. An apparatus in accordance with claim 17 wherein the solar concentrator comprises a refracting lens.

21. An apparatus in accordance with claim 17 further comprising a motor configured to move the solar concentrator to track movement of the sun in the sky.

22. An apparatus in accordance with claim 13 wherein the energy generator system comprises photovoltaic cells.

23. An apparatus in accordance with claim 13 further comprising at least one electric meter for each said consumer, said at least one electric meter configured to separately measure usage of the generated electrical power and usage of the electrical power converted from the stored kinetic energy.

24. An apparatus in accordance with claim 23 wherein said electric meter includes a timer configured to indicate when solar radiation is available.

25. An apparatus in accordance with claim 13 wherein the at least one flywheel is buried underground.

26. An apparatus in accordance with claim 13 wherein the energy generator system and the at least one flywheel are located at a central generating plant.
